(19) United States
(12) Patent Application Publication
(10) Pub. No.: US 2026/0063546 A1
(43) Pub. Date: Mar. 5, 2026

(54) INTERFEROMETRIC MEASUREMENT METHOD AND INTERFEROMETRIC MEASUREMENT APPARATUS

(71) Applicant: HAMAMATSU PHOTONICS K.K., Hamamatsu-shi (JP)

(72) Inventors: Hisanari TAKAHASHI, Shizuoka (JP); Ginji SUGIURA, Shizuoka (JP); Hiroshi SATOZONO, Shizuoka (JP); Naoya KAWAI, Shizuoka (JP)

(73) Assignee: HAMAMATSU PHOTONICS K.K., Hamamatsu-shi (JP)

(21) Appl. No.: 19/317,640

(22) Filed: Sep. 3, 2025

(30) Foreign Application Priority Data
Sep. 4, 2024 (JP) 2024-152350

(51) Int. Cl. G01N 21/45

(52) U.S. Cl. CPC G01N 21/45

(57) ABSTRACT

An interferometric measurement method using an interferometric measurement apparatus includes a first step of acquiring a first interference waveform in a first state by changing an optical path length difference between a first optical path and a second optical path in the first state in which a sample is not disposed in the second optical path, a second step of converting the first interference waveform into a first electric field amplitude waveform, a third step of acquiring a second interference waveform in a second state by changing the optical path length difference in the second state in which the sample is disposed in the second optical path, a fourth step of converting the second interference waveform into a second electric field amplitude waveform, and a fifth step of acquiring a physical property of the sample based on the peak amplitudes of the first and second electric field amplitude waveforms.

### TECHNICAL FIELD

The present disclosure relates to an interferometric measurement method and an interferometric measurement apparatus.

### CROSS-REFERENCE TO RELATED APPLICATIONS

This application claims the benefit of priority from Japanese Patent Application No. 2024-152350 filed on Sep. 4, 2024, the entire contents of which are incorporated herein by reference.

### BACKGROUND

Conventionally, as a method for measuring a physical property of a sample (for example, an impurity concentration of a semiconductor), a contact-type measurement method such as a two-probe method or a four-probe method, in which a probe is brought into contact with a surface of the sample to measure a resistance of the sample, has been used (for example, Patent Document 1: Japanese Unexamined Patent Application Publication No. H2-238646).

### SUMMARY

In the contact-type measurement method as described above, it is necessary to accurately bring the probe into contact with a predetermined position on the sample, and if the position where the probe is brought into contact is displaced, there is a risk of damaging the sample. To avoid such a problem, a non-contact (non-destructive) method for measuring the physical property of the sample is desired.

Therefore, an object of the present disclosure is to provide an interferometric measurement method and an interferometric measurement apparatus that can appropriately measure the physical property of a sample in a non-contact manner.

The present disclosure includes the following interferometric measurement methods [1] to and interferometric measurement apparatus [11].

[1] An interferometric measurement method using an interferometric measurement apparatus, wherein the interferometric measurement apparatus includes: a light source that outputs measurement light having a frequency included in a range of 0.1 THz to 50 THz; an interferometric optical system that includes: a beam splitter that splits the measurement light into a first split light and a second split light; a first optical path for the first split light from being output from the beam splitter to re-entering the beam splitter; and a second optical path, which is different from the first optical path, for the second split light from being output from the beam splitter to re-entering the beam splitter, the second optical path being configured to be switchable between a first state in which a sample is not disposed and a second state in which the sample is disposed, wherein the interferometric optical system combines the first split light and the second split light re-entering the beam splitter, and an optical path length difference between the first optical path and the second optical path is variable; a photomultiplier tube that outputs an electrical signal value corresponding to an incident light intensity of interference light of the measurement light, the interference light being generated by combination of the first split light and the second split light at the beam splitter; an interference intensity measurement unit that measures an intensity of the interference light based on the electrical signal value output from the photomultiplier tube; and an electric field amplitude calculation unit that determines an electric field amplitude of the interference light from the intensity of the interference light measured by the interference intensity measurement unit, based on a relationship between a value of an electric field amplitude of light incident on the photomultiplier tube and a value of an electrical signal output from the photomultiplier tube, the method including: a first step of acquiring a first interference waveform indicating the intensity of the interference light for each optical path length difference in the first state, by performing the measurement by the interference intensity measurement unit while changing the optical path length difference in the first state; a second step of converting the first interference waveform into a first electric field amplitude waveform, which is a waveform of the electric field amplitude, by the electric field amplitude calculation unit; a third step of acquiring a second interference waveform indicating the intensity of the interference light for each optical path length difference in the second state, by performing the measurement by the interference intensity measurement unit while changing the optical path length difference in the second state;

a fourth step of converting the second interference waveform into a second electric field amplitude waveform, which is a waveform of the electric field amplitude, by the electric field amplitude calculation unit; and a fifth step of acquiring a measurement value regarding a physical property of the sample, based on an electric field amplitude corresponding to each peak of the first electric field amplitude waveform and the second electric field amplitude waveform.

In the interferometric measurement method of [1], for each of a first state in which a sample is not disposed in one optical path (the second optical path) of the interferometric optical system and a second state in which the sample is disposed, measurement of interference light is performed while changing an optical path length difference, thereby obtaining a first interference waveform and a second interference waveform indicating an intensity of the interference light for each optical path length difference. Furthermore, for each of the first interference waveform and the second interference waveform, the intensity of the interference light is converted into an electric field amplitude, thereby obtaining a first electric field amplitude waveform and a second electric field amplitude waveform. Then, based on an electric field amplitude corresponding to each peak of these waveforms, a measurement value regarding a physical property of the sample can be obtained. That is, according to the interferometric measurement method, the physical property of the sample can be grasped based on the measurement value obtained by irradiating the sample with light (the second split light) without bringing a measuring instrument (probe) or the like into contact with the sample. Therefore, according to the interferometric measurement method, the physical property of the sample can be appropriately measured in a non-contact manner.

[2] The interferometric measurement method according to [1], wherein the sample is a semiconductor material.

According to the configuration of [2], a physical property such as a carrier density of a sample that is a semiconductor material can be easily measured by a non-contact measurement method.

[3] The interferometric measurement method according to [2], wherein a resistivity of the semiconductor material is 4 (2 cm or less.

According to the configuration of [3], by using a semiconductor material in which a change in an amplitude reflectance of the measurement light (a peak value of the second electric field amplitude waveform/a peak value of the first electric field amplitude waveform) with respect to a change in a carrier density is relatively large as the sample, the physical property of the sample can be easily measured based on the amplitude reflectance.

[4] The interferometric measurement method according to any one of [1] to [3], wherein the frequency of the measurement light is included in a range of 0.1 THz to 30 THz.

According to the configuration of [4], since a change in the amplitude reflectance with respect to a change in the physical property (for example, carrier density) of the sample can be made relatively large, the physical property of the sample can be measured with higher accuracy based on the amplitude reflectance.

[5] The interferometric measurement method according to [4], wherein the frequency of the measurement light is included in a range of 0.1 THz to 10 THz.

According to the configuration of [5], the effect of [4] can be obtained more suitably.

[6] The interferometric measurement method according to any one of [1] to [5], wherein in the fifth step, the measurement value regarding the physical property of the sample is acquired based on an electric field amplitude corresponding to a largest peak of the first electric field amplitude waveform and an electric field amplitude corresponding to a largest peak of the second electric field amplitude waveform.

According to the configuration of [6], by focusing on the electric field amplitude of the largest peak of each of the first electric field amplitude waveform and the second electric field amplitude waveform, measurement with a high S/N ratio can be performed.

[7] The interferometric measurement method according to any one of [1] to [6], wherein the interferometric measurement apparatus further includes an excitation optical system that irradiates the sample disposed in the second optical path with excitation light when in the second state, the third step acquires the second interference waveform for each delay time by: controlling a delay time, which is a time difference between a timing at which the second split light is incident on the sample and a timing at which the sample is irradiated with the excitation light by the excitation optical system, to change a combination of the delay time and the optical path length difference; and performing the measurement by the interference intensity measurement unit for each combination, the fourth step acquires the second electric field amplitude waveform for each delay time, and the fifth step acquires a measurement value regarding a time response of the sample, based on an electric field amplitude corresponding to each peak of the first electric field amplitude waveform and the second electric field amplitude waveform for each delay time.

According to the configuration of [7], a time response of the physical property of the sample irradiated with the excitation light can be evaluated.

[8] The interferometric measurement method according to [7], wherein the sample is a semiconductor material, and the excitation light is visible light or near-infrared light.

According to the configuration of [8], since carriers of the semiconductor sample can be efficiently excited by the excitation light, the physical property of the semiconductor sample can be suitably evaluated.

[9] The interferometric measurement method according to [7] or [8], wherein a part of light generated in the light source is made incident on an optical crystal to generate the measurement light, and another part of the light generated in the light source is input to the excitation optical system as the excitation light, and the delay time is controlled by changing an optical path length of the excitation light in the excitation optical system.

According to the configuration of [9], the measurement light and the excitation light can be generated from one light source, and the delay time can be easily controlled by changing the optical path length of the excitation optical system.

[10] The interferometric measurement method according to any one of [2] to [9], wherein processes of the third step, the fourth step, and the fifth step are repeatedly executed while changing an impurity concentration of the sample.

According to the configuration of [10], by grasping the physical property information of the sample in each state while changing the impurity concentration of the sample, a process of adjusting the impurity concentration of the sample to a desired range can be easily and efficiently performed.

[11] An interferometric measurement apparatus including: an interferometric optical system that includes: a beam splitter that splits measurement light having a frequency included in a range of 0.1 THz to 50 THz into a first split light and a second split light; a first optical path for the first split light from being output from the beam splitter to re-entering the beam splitter; and a second optical path, which is different from the first optical path, for the second split light from being output from the beam splitter to re-entering the beam splitter, the second optical path being configured to be switchable between a first state in which a sample is not disposed and a second state in which the sample is disposed, wherein the interferometric optical system combines the first split light and the second split light re-entering the beam splitter, and an optical path length difference between the first optical path and the second optical path is variable; an excitation optical system that irradiates the sample disposed in the second optical path with excitation light when in the second state; a light source that generates light, generates the measurement light by causing a part of the light to be incident on an optical crystal, and inputs another part of the light to the excitation optical system as the excitation light; a photomultiplier tube that outputs an electrical signal value corresponding to an incident light intensity of interference light of the measurement light, the interference light being generated by combination of the first split light and the second split light at the beam splitter; an interference intensity measurement unit that measures an intensity of the interference light based on the electrical signal value output from the photomultiplier tube; and an electric field amplitude calculation unit that determines an electric field amplitude of the interference light from the intensity of the interference light measured by the interference intensity measurement unit, based on a relationship between a value of an electric field amplitude of light incident on the photomultiplier tube and a value of an electrical signal output from the photomultiplier tube, wherein an optical path length of the excitation light in the excitation optical system is configured to be variable.

The interferometric measurement apparatus can implement the interferometric measurement method described above, and thus can appropriately measure the physical property of the sample in a non-contact manner. Further, the interferometric measurement apparatus includes the excitation optical system together with the interferometric optical system, and thus can evaluate the time response of the physical property of the sample irradiated with the excitation light. Further, since the measurement light and the excitation light can be generated from one light source, the apparatus configuration can be simplified and downsized as compared with a case where the measurement light and the excitation light are output from separate light sources. Further, by changing the optical path length of the excitation optical system, the delay time between the timing at which the measurement light (the second split light) is incident on the sample and the timing at which the excitation light is irradiated can be easily set, so that a measurement value regarding the time response can be easily obtained.

According to the present disclosure, it is possible to provide an interferometric measurement method and an interferometric measurement apparatus that can appropriately measure the physical property of a sample in a non-contact manner.

### BRIEF DESCRIPTION OF THE DRAWINGS

FIG. 1 is a diagram showing a configuration example of an interferometric measurement apparatus 1 according to a first embodiment.

FIG. 2 is a diagram showing a configuration example of a photomultiplier tube 30.

FIG. 3 is an example of a graph showing a time dependence of a voltage signal V output from the photomultiplier tube 30.

FIG. 4 is an example of a graph showing a relationship (FN equation) between an output value of the photomultiplier tube 30 and an electric field amplitude of incident light, which is obtained by a fitting process.

FIG. 5 is a table showing an example of a correspondence relationship between the electric field amplitude of the incident light and the output value of the photomultiplier tube 30 from a calculation using the FN equation.

FIG. 6 is a flowchart showing an example (a first measurement example) of an interferometric measurement method using the interferometric measurement apparatus 1.

FIG. 7 is a diagram showing an example of a first interference waveform W1 and a second interference waveform W2.

FIG. 8 is a diagram showing an example of a first electric field amplitude waveform WE1 and a second electric field amplitude waveform WE2.

FIG. 9 is a graph showing a relationship of an amplitude reflectance R for each frequency of measurement light for each of a plurality of Si semiconductor substrates having different resistivities p.

FIG. 10 is a graph showing a relationship of an amplitude reflectance R for each frequency of measurement light for each of a plurality of GaN semiconductor substrates having different resistivities p.

FIG. 11 is a diagram showing a configuration example of an interferometric measurement apparatus 1A according to a second embodiment.

FIG. 12 is a flowchart showing an example (a second measurement example) of an interferometric measurement method using the interferometric measurement apparatus 1A.

FIG. 13 is a diagram showing an example of a first interference waveform W1 and a second interference waveform W2(t) corresponding to a certain delay time t.

FIG. 14 is a diagram showing an example of a first electric field amplitude waveform WE1 and a second electric field amplitude waveform WE2 corresponding to a certain delay time t.

FIG. 15 is a diagram showing an example of an amplitude reflectance R(t) for each delay time.

### DETAILED DESCRIPTION

An embodiment of the present disclosure will be described in detail with reference to the drawings. In the following description, the same or corresponding elements are denoted by the same reference numerals, and redundant descriptions are omitted.

### First Embodiment

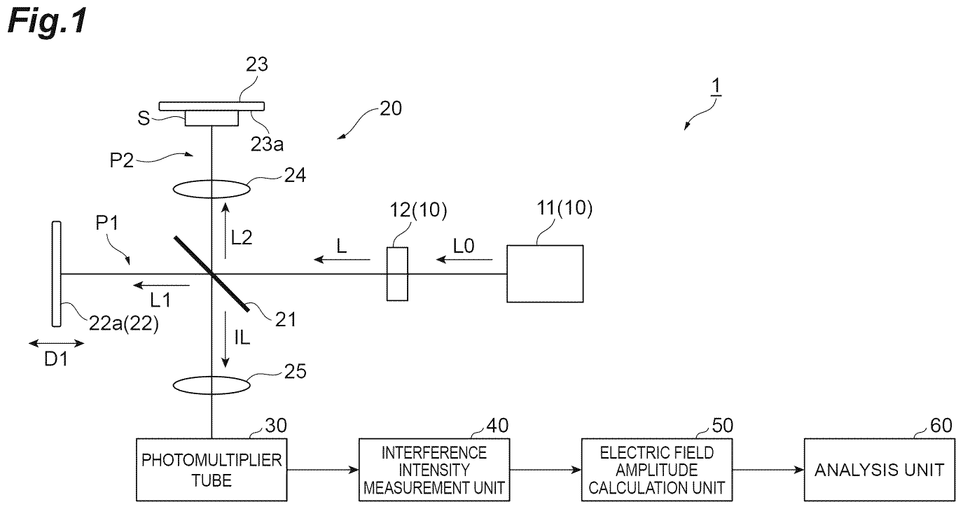

With reference to FIGS. 1 to 9, an interferometric measurement apparatus 1 according to a first embodiment will be described, and an interferometric measurement method (a first measurement example) using the interferometric measurement apparatus 1 will be described. As shown in FIG. 1, the interferometric measurement apparatus 1 includes a light source 10, an interferometric optical system 20, a photomultiplier tube 30, an interference intensity measurement unit 40, an electric field amplitude calculation unit 50, and an analysis unit 60. The interference intensity measurement unit 40, the electric field amplitude calculation unit 50, and the analysis unit 60 may be configured by, for example, a computer system including a processor, a memory, a storage, a communication device, and the like. That is, each function of the interference intensity measurement unit 40, the electric field amplitude calculation unit 50, and the analysis unit 60 is executed, for example, by the hardware elements as described above operating according to a predetermined program.

The light source 10 outputs measurement light L having a frequency included in a range of 0.1 THz to 50 THz. In the present embodiment, as an example, the light source 10 includes an output unit 11 that outputs visible light or near-infrared light L0, and an optical crystal 12 that converts the light L0 into measurement light L.

The output unit 11 is, for example, an ultrashort pulse laser. As an example, the output unit 11 is a femtosecond laser source. Examples of the output unit 11 include a Ti:sapphire pulse laser (wavelength 800 nm), an Er pulse fiber laser (wavelength 1550 nm), a Yb pulse fiber laser (wavelength 1030 nm), a Tm pulse fiber laser (wavelength 1900 nm), an Nd pulse solid-state laser (wavelength 1030 nm), and the like.

The optical crystal 12 is formed of a material capable of generating the measurement light L (for example, a terahertz wave) included in the above-described frequency range. Examples of the optical crystal 12 include nonlinear optical crystals such as a ZnTe crystal (excitation wavelength 800 nm), a GaSe crystal (excitation wavelength 800 nm), a DAST crystal (excitation wavelength 1.5 μm), a GaAs photoconductive antenna (excitation wavelength 800 nm), and an InGaAs photoconductive antenna (excitation wavelength 1.5 μm). The optical crystal 12 is disposed downstream of the output unit 11. The light L0 output from the output unit 11 passes through the optical crystal 12 and is converted into the measurement light L in the above-described frequency range.

However, the form of the light source 10 is not limited to the above. For example, the light source 10 may be configured by an injection-seeded THz parametric generator (is-TPG) using an Nd microchip laser (wavelength 1030 nm) as an excitation laser. Further, the light source 10 may be a light source capable of outputting continuous light. For example, the light source 10 may be a resonant tunneling diode (RTD), an impact avalanche and transit time (IMPATT) diode, a quantum cascade laser source, a THz gas laser source, or the like.

In the present embodiment, the output unit 11 is a Ti:sapphire pulse laser, and the light L0 is visible to near-infrared light with a wavelength of 800 nm. The optical crystal 12 is a ZnTe crystal, and the measurement light L is a terahertz wave with a frequency of 0.5 THz.

The interferometric optical system 20 includes a beam splitter 21, a first mirror 22, a second mirror 23, and lenses 24 and 25. The beam splitter 21 may be configured by, for example, silicon or an ITO mirror, or the like. The interferometric optical system 20 has a first optical path P1 which is a round-trip path between the beam splitter 21 and the first mirror 22, and a second optical path P2 which is a round-trip path between the beam splitter 21 and the second mirror 23. The first optical path P1 is an optical path for a first split light L1, which is one of the lights split by the beam splitter 21, from being output from the beam splitter 21 to re-entering the beam splitter 21. The second optical path P2 is an optical path for a second split light L2, which is the other of the lights split by the beam splitter 21, from being output from the beam splitter 21 to re-entering the beam splitter 21.

The beam splitter 21 splits the measurement light L output from the light source 10 into the first split light L1 and the second split light L2. In the present embodiment, the beam splitter 21 is disposed between the light source 10 (in the present embodiment, the optical crystal 12) and the first mirror 22. The first split light L1 is a component of the measurement light L that is transmitted (travels straight) through the beam splitter 21. The first split light L1 is reflected by a mirror surface 22a of the first mirror 22 and re-enters the beam splitter 21 (a surface opposite to the incident surface of the measurement light L). The second split light L2 is a component that is reflected by the beam splitter 21 and travels in a direction orthogonal to a traveling direction of the measurement light L. The second split light L2 is reflected by a mirror surface 23a of the second mirror 23 or a sample S disposed on the mirror surface 23a, and re-enters the beam splitter 21 (the same surface as the incident surface of the measurement light L).

In the interferometric optical system 20, the second optical path P2 is configured to be switchable between a first state in which a predetermined sample S is not disposed and a second state in which the sample S is disposed. FIG. 1 shows the second state. As an example, the second state is a state in which the sample S is disposed on the mirror surface 23a of the second mirror 23. The sample S is, for example, a semiconductor material. In the present embodiment, the sample S is a plate-shaped semiconductor substrate (semiconductor wafer). Specific examples of such a sample S include a silicon substrate, a GaN substrate, a SiC substrate, a GaAs substrate, and the like.

In the interferometric optical system 20, an optical path length difference between the first optical path P1 and the second optical path P2 is configured to be variable. As an example, the first mirror 22 that forms the first optical path P1 is configured to be movable in a direction D1 parallel to a traveling direction of the first split light L1 (a direction perpendicular to the mirror surface 22a). A position of the first mirror 22 in the direction D1 is set, for example, such that an optical path length difference Δd between the first optical path P1 and the second optical path P2 is near zero as an initial state. That is, in the example of FIG. 1, as the initial state, a distance from the beam splitter 21 to the mirror surface 22a of the first mirror 22 and a distance from the beam splitter 21 to the mirror surface 23a of the second mirror 23 are set to be substantially the same.

The mechanism for changing the optical path length difference Δd is not limited to the mechanism of the present embodiment (the mechanism that makes the first mirror 22 movable in the direction D1). Instead of (or in addition to) the first mirror 22, the second mirror 23 may be configured to be movable in a direction parallel to a traveling direction of the second split light L2 (a direction perpendicular to the mirror surface 23a). Alternatively, a mechanism capable of rapidly changing the optical path length difference Δd may be provided by interposing a rotating mirror capable of swinging (rotating) within a predetermined angle range in at least one of the first optical path P1 and the second optical path P2.

The beam splitter 21 combines the first split light L1 re-entering the beam splitter 21 through the first optical path P1 and the second split light L2 re-entering the beam splitter 21 through the second optical path P2 to generate interference light IL. In the present embodiment, a component of the first split light L1 that re-enters the beam splitter 21 (a surface opposite to the incident surface of the measurement light L) and is reflected by the beam splitter 21, and a component of the second split light L2 that re-enters the beam splitter 21 (the same surface as the incident surface of the measurement light L) and is transmitted through the beam splitter 21 are combined, whereby the interference light IL is emitted from the beam splitter 21 toward a side opposite to a side where the second mirror 23 is located.

The lens 24 is disposed between the beam splitter 21 and the second mirror 23 in the second optical path P2. The lens 24 is a lens that condenses the second split light L2 in order to increase an incidence efficiency of the second split light L2 on the sample S disposed on the mirror surface 23a in the second state. The lens 24 is, for example, a condensing lens for a terahertz wave band with a focal length of 50 mm (for example, Tsurupica (registered trademark) or the like).

The lens 25 is disposed downstream of the beam splitter 21 in an optical path of the interference light IL (that is, between the beam splitter 21 and the photomultiplier tube 30). The lens 25 is a lens that condenses the interference light IL in order to increase an incidence efficiency of the interference light IL on the photomultiplier tube 30. The lens 25 is, for example, a condensing lens for a terahertz wave band similar to the lens 24.

The photomultiplier tube 30 is disposed downstream of the beam splitter 21 at a position toward which the interference light IL output from the beam splitter 21 travels. The photomultiplier tube 30 has sensitivity in a wavelength range of the measurement light L (in the present embodiment, a light band including a terahertz wave), and outputs an electrical signal value corresponding to an incident light intensity of the interference light IL.

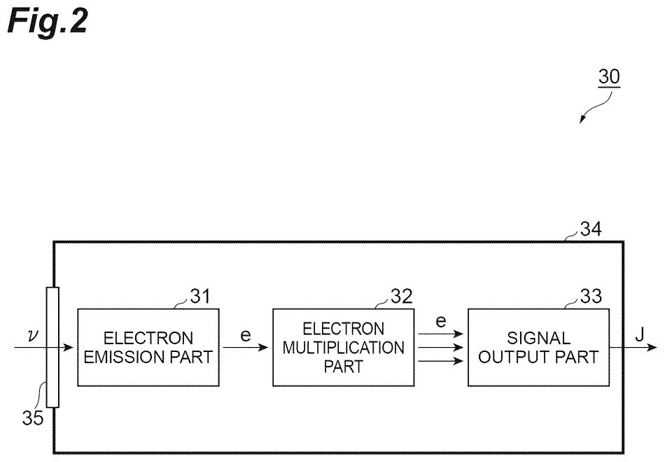

FIG. 2 is a block diagram showing a configuration example of the photomultiplier tube 30. The photomultiplier tube 30 has an electron emission part 31, an electron multiplication part 32, and a signal output part 33 disposed inside a housing 34 in which an inside is maintained in a vacuum. The housing 34 is provided with a window part 35.

When light ν transmitted through the window part 35 is incident, the electron emission part 31 emits electrons e by the light incidence. The electron emission part 31 is a photoelectric conversion unit designed to have sensitivity in a band of the measurement light L to be detected. The electron emission part 31 has, for example, a configuration in which a metamaterial structure (metasurface) is formed on a main surface of a substrate, and emits electrons e by light incidence on the metasurface.

The electron multiplication part 32 multiplies the electrons e emitted from the electron emission part 31. The electron multiplication part 32 includes a plurality of stages of dynodes or a microchannel plate. An electron multiplication factor in the electron multiplication part 32 corresponds to a voltage applied to the plurality of stages of dynodes or the microchannel plate. The signal output part 33 collects the electrons e multiplied by the electron multiplication part 32 and outputs them as a current signal J. The interference intensity measurement unit 40, which will be described later, may be input with the current signal J output from the signal output part 33, or may be input with a voltage signal after the current signal J is converted by an IV conversion circuit. In the present embodiment, the voltage signal is input to the interference intensity measurement unit 40 as the electrical signal value output from the photomultiplier tube 30.

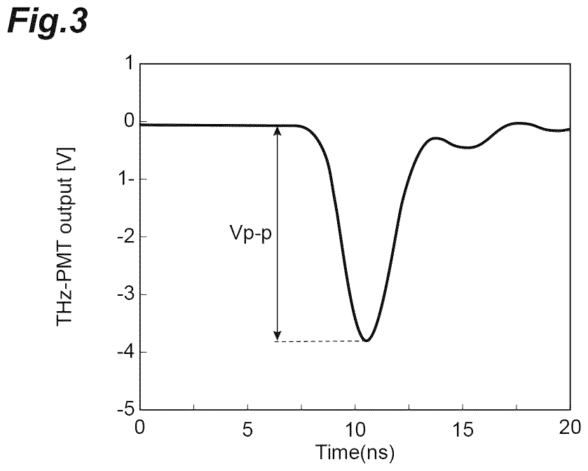

The interference intensity measurement unit 40 measures an intensity of the interference light IL incident on the photomultiplier tube 30 based on an electrical signal (in the present embodiment, a voltage signal) output from the photomultiplier tube 30. FIG. 3 is a graph showing a time dependence of a voltage signal V output from the photomultiplier tube 30. The interference intensity measurement unit 40 reads a time change of the voltage signal V output from the photomultiplier tube 30 when the optical path length difference Δd is set to a certain value. The interference intensity measurement unit 40 can obtain an amplitude Vp-p of the voltage signal V at this time as the intensity of the interference light IL corresponding to the optical path length difference Δd.

The electric field amplitude calculation unit 50 determines an electric field amplitude of the interference light IL from the intensity of the interference light IL (Vp-p in the present embodiment) measured by the interference intensity measurement unit 40, based on a relationship between a value of an electric field amplitude of light incident on the photomultiplier tube 30 and a value of an electrical signal (voltage signal) output from the photomultiplier tube 30.

The value of the electrical signal output from the photomultiplier tube 30 may be described by a polynomial with an electric field amplitude E of the light incident on the photomultiplier tube 30 as a variable, but may also be described using the following equation (1) representing an efficiency of electron emission in a metasurface. This equation represents a relationship between a current JFN emitted from the metasurface and the electric field amplitude E of the incident light (interference light IL), and is called Fowler-Nordheim relations (hereinafter referred to as “FN equation”). The FN equation is an example of information indicating the relationship between the electric field amplitude and the value of the electrical signal output from the photomultiplier tube 30.

$${J}_{FN} ( E ) = \frac{{a}_{FN}}{{t}_{F}^{2}} \frac{{( β E )}^{2}}{Φ} exp ( - \frac{{v}_{F} {b}_{FN} {Φ}^{3 / 2}}{β E} ) \qquad ( 1 )$$

In this FN equation, a_{FN} and b_{FN} are called FN constants and are certain constant values. β is a field enhancement factor, and is, for example, about 400. Φ is a work function of a material of the metasurface of the electron emission part 31, and is 3.5 eV for gold. t_{F} and ν_{F} are constants. When the electric field amplitude of the incident light is not large, each value of t_{F} and ν_{F} may be 1. In that case, the FN equation is expressed by the following equation (2).

$${J}_{FN} ( E ) = {a}_{FN} \frac{{( β E )}^{2}}{Φ} exp ( - \frac{{b}_{FN} {Φ}^{3 / 2}}{β E} ) \qquad ( 2 )$$

The FN equation represents the relationship between the current J_{FN} emitted from the electron emission part 31 of the photomultiplier tube 30 and the electric field amplitude E of the incident light, but the relationship between an output value of the photomultiplier tube 30 and the electric field amplitude E of the incident light can also be represented in the same manner.

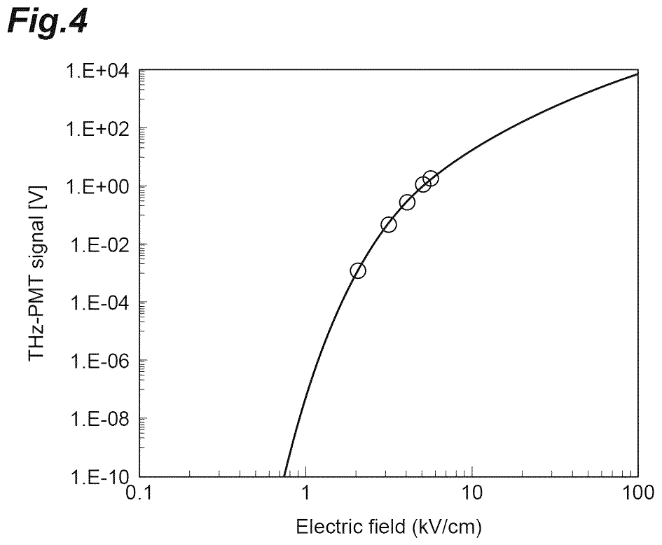

It is necessary to determine the respective values of a_{FN} and b_{FN} in the FN equation. For that purpose, the electric field amplitude E of the incident light is set to each value, an output value (amplitude Vp-p) of the photomultiplier tube 30 is measured, and by performing a fitting process using these measurement values, the respective values of a_{FN} and b_{FN} can be determined. FIG. 4 is a graph showing a relationship (FN equation) between the output value of the photomultiplier tube 30 and the electric field amplitude E of the incident light, which is obtained by the fitting process. In this figure, five measurement values are indicated by circles.

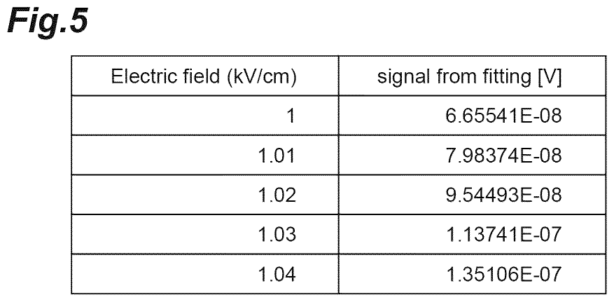

The electric field amplitude calculation unit 50 can determine the electric field amplitude of the interference light IL from the intensity of the interference light IL measured by the interference intensity measurement unit 40, for example, based on the FN equation described above. To determine the electric field amplitude E of the incident light from the output value of the photomultiplier tube 30 using the FN equation, for example, the following may be performed. The output value of the photomultiplier tube 30 is predetermined for each value of the electric field amplitude E of the incident light by a calculation using the FN equation. FIG. 5 is a table showing an example of a correspondence between the electric field amplitude E of the incident light and the output value of the photomultiplier tube 30 by a calculation using the FN equation. The electric field amplitude calculation unit 50 determines the electric field amplitude E of the incident light that is closest to the fitting value from the actual output value of the photomultiplier tube 30 (the intensity of the interference light IL obtained by the interference intensity measurement unit 40). Alternatively, the electric field amplitude E of the incident light may be determined by an interpolation calculation.

The analysis unit 60 executes various calculations for acquiring a measurement value regarding a physical property of the sample S based on a calculation result (the electric field amplitude E for each optical path length difference Δd) by the electric field amplitude calculation unit 50. An example of a process of the analysis unit 60 will be described together with a flowchart described later.

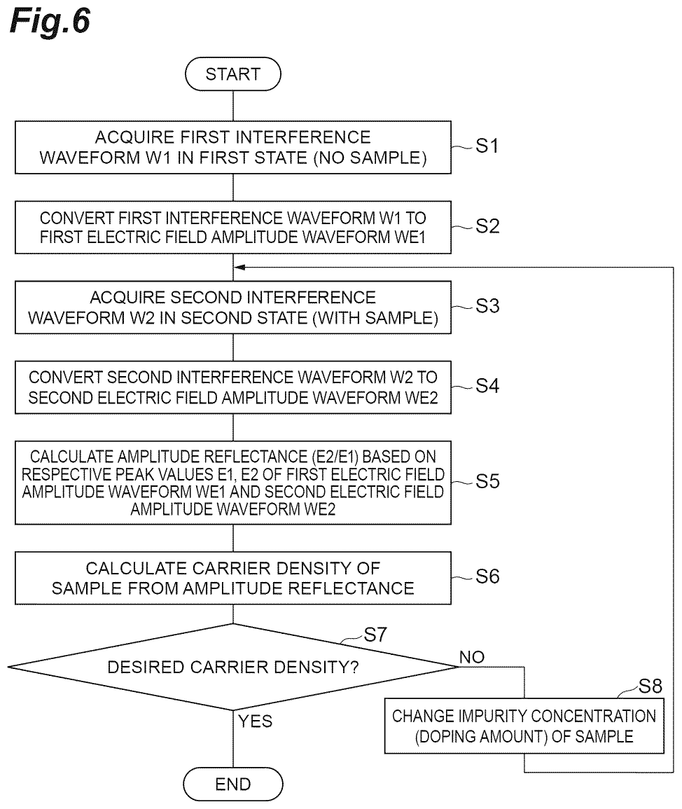

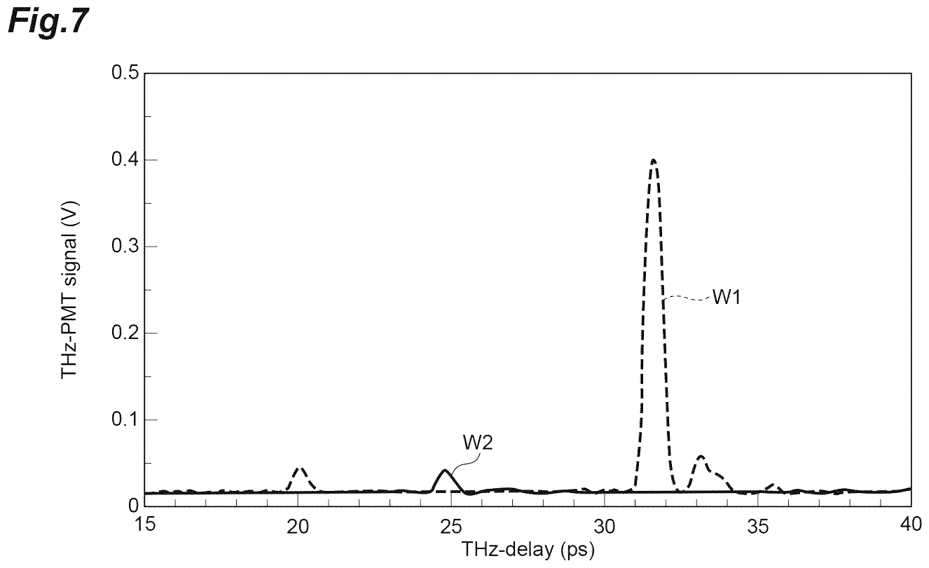

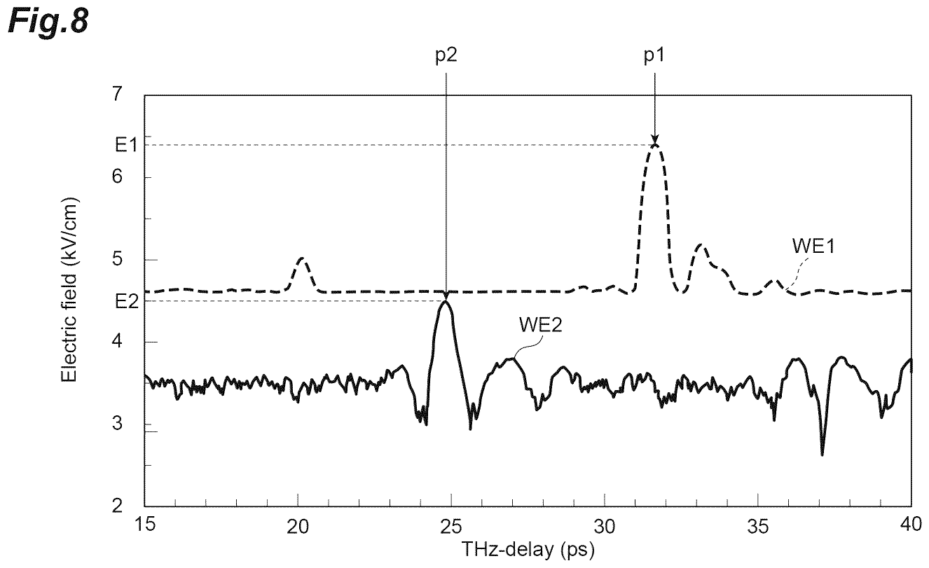

An example (a first measurement example) of an interferometric measurement method by the interferometric measurement apparatus 1 will be described with reference to the flowchart of FIG. 6 and examples of measurement results of FIGS. 7 and 8. As an example, in the first measurement example, it is used for an application of estimating a carrier density of the sample S (wafer surface) at each stage and changing an impurity concentration (doping concentration) of the sample S until the carrier density reaches a desired value.

In step S1 (first step), by performing measurement by the interference intensity measurement unit 40 while changing the optical path length difference Δd in a first state (a state in which the sample S is not disposed), a first interference waveform W1 (FIG. 7) indicating an intensity of the interference light IL for each optical path length difference Δd in the first state is acquired.

More specifically, in a state where the sample S is not disposed in the second optical path P2 (that is, a state where the sample S does not exist in FIG. 1), and in a state where the optical path length difference Δd is set to a certain value, the measurement light L is output from the light source 10, whereby the interference intensity measurement unit 40 measures the intensity (Vp-p) of the interference light IL corresponding to the optical path length difference Δd. The first interference waveform W1 can be obtained by performing the above-described measurement for each value of the optical path length difference Δd while changing the optical path length difference Δd (in the present embodiment, while scanning the first mirror 22 in the direction D1). A horizontal axis of the graph of FIG. 7 indicates a time difference Δt (=Δd/c) corresponding to the optical path length difference Δd. Here, c is a speed of light in a vacuum. A vertical axis of the graph of FIG. 7 indicates the intensity (Vp-p) of the interference light IL.

In step S2 (second step), the electric field amplitude calculation unit 50 converts the first interference waveform W1 into a first electric field amplitude waveform WE1 (FIG. 8) which is a waveform of an electric field amplitude. The electric field amplitude calculation unit 50 can obtain the first electric field amplitude waveform WE1 by converting a value (Vp-p) of the first interference waveform W1 into an electric field amplitude using the relationship based on the FN equation as described above (for example, a correspondence table (FIG. 5) obtained from the FN equation). A horizontal axis of the graph of FIG. 8 indicates the same time difference Δt as the graph of FIG. 7. On the other hand, a vertical axis of the graph of FIG. 8 indicates the electric field amplitude (kV/cm) of the interference light IL.

Subsequently, the sample S is disposed in the second optical path P2 (on the mirror surface 23a of the second mirror 23), and the same measurement as in steps S1 and S2 described above is performed.

In step S3 (third step), by performing measurement by the interference intensity measurement unit 40 while changing the optical path length difference Δd in a second state (a state in which the sample S is disposed), a second interference waveform W2 (FIG. 7) indicating an intensity of the interference light IL for each optical path length difference Δd in the second state is acquired. The process of step S3 is different from step S1 only in that the sample S is disposed, and is otherwise the same as the process of step S1.

In step S4 (fourth step), the electric field amplitude calculation unit 50 converts the second interference waveform W2 into a second electric field amplitude waveform WE2 (FIG. 8) which is a waveform of an electric field amplitude. The process of step S4 is different from step S2 only in that the sample S is disposed, and is otherwise the same as the process of step S2.

Subsequently, a measurement value regarding a physical property of the sample S is acquired by the analysis unit 60 from the first electric field amplitude waveform WE1 and the second electric field amplitude waveform WE2 obtained in steps S2 and S4 (steps S5 and S6) (fifth step). In this example (the first measurement example), as the measurement value regarding the physical property of the sample S, first, an amplitude reflectance R is calculated, and further, a carrier density of the sample S is calculated from the amplitude reflectance R.

In step S5, a measurement value (amplitude reflectance R) regarding the physical property of the sample S is acquired based on electric field amplitudes E1 and E2 corresponding to respective peaks p1 and p2 of the first electric field amplitude waveform WE1 and the second electric field amplitude waveform WE2. For example, by assuming that a reflectance in a state where the sample is not disposed (that is, a reflectance of the second split light L2 at the mirror surface 23a) is 100%, the analysis unit 60 can calculate a value (E2/E1) obtained by dividing a value of the electric field amplitude E2 of the peak p2 in the second state by a value of the electric field amplitude E1 of the peak p1 in the first state as the amplitude reflectance R.

Here, in the example of FIG. 8, the electric field amplitudes E1 and E2 corresponding to the largest peaks p1 and p2 of the respective electric field amplitude waveforms WE1 and WE2 were used, but for the calculation of the amplitude reflectance R, electric field amplitudes corresponding to the second and subsequent peaks of the respective electric field amplitude waveforms WE1 and WE2 may be used. However, as shown in FIG. 8, since the largest peaks p1 and p2 of the respective electric field amplitude waveforms WE1 and WE2 are more prominent than the second and subsequent peaks, by focusing on the electric field amplitudes E1 and E2 of the largest peaks p1 and p2 of the respective electric field amplitude waveforms WE1 and WE2, measurement with a high S/N ratio can be performed.

In step S6, the analysis unit 60 calculates (estimates) the carrier density of the sample S from the amplitude reflectance R. Hereinafter, an example of a process for calculating the carrier density will be described.

An amplitude reflectance R(ω) (THz spectroscopic reflectance) at a certain angular frequency ω from the semiconductor sample S is expressed by the following equation (3). Regarding the angular frequency ω, by evaluating a spectral sensitivity of the photomultiplier tube 30 in advance and determining a center frequency of the photomultiplier tube 30, the angular frequency ω corresponding to the center frequency can be grasped.

$$R ( ω ) = 1 - ( n + 1 ) / ( n + 1 - i ω d ε ( ω ) / c ) \qquad ( 3 )$$

Here, ω indicates an angular frequency, n indicates a complex refractive index of the sample S, i indicates an imaginary number, d indicates a penetration depth (˜13.5 μm), and ε(ω) indicates a dielectric constant of the sample S. By transforming the above equation (3) and moving only the dielectric constant ε(ω) to the left side, the following equation (4) is obtained.

$$ε ( ω ) = [ i ( n + 1 ) c / ω d ] [ R ( ω ) / 1 - R ( ω ) ] \qquad ( 4 )$$

On the other hand, the dielectric constant ε(ω) can also be expressed by the following equations (5) and (6).

$$ε ( ω ) = {ε}_{∞} - {ω}_{p}^{2} / [ ω ( ω + i γ ) ] \qquad ( 5 )$$

$$γ = {( {n}_{c} {e}^{2} / {ε}_{0} {m}^{*} )}^{( 1 / 2 )} \qquad ( 6 )$$

Here, ε_{∞} indicates a dielectric constant at a high frequency limit (=11.7), ωₚ indicates a plasma frequency, γ indicates a damping rate, n_{c} indicates a carrier density, m* indicates a relative effective mass, e indicates an elementary charge, and ε₀ indicates a permittivity of vacuum.

For example, the analysis unit 60 can calculate the dielectric constant ε(ω) based on the amplitude reflectance R(ω) (=E2/E1) calculated in step S5 and the above equation (4), and determine ωₚ and γ by performing fitting using the above equation (5). Subsequently, the analysis unit 60 can calculate the carrier density n_{c} based on the above equation (5). Alternatively, a known damping rate for the sample S may be applied to γ, and a dielectric constant for each carrier density n_{c} may be calculated in advance based on the above equations (5) and (6). In this case, the analysis unit 60 can estimate the carrier density corresponding to the amplitude reflectance R(ω) by comparing the dielectric constant ε determined from the amplitude reflectance R(ω) and the above equation (4) with the dielectric constant for each carrier density ne determined as described above. The analysis unit 60 can obtain the carrier density as physical property information of the sample S from the amplitude reflectance R(ω) by performing the above-described calculation, for example.

In step S7, when the carrier density calculated by the analysis unit 60 is included in a predetermined desired range (step S7: YES), the measurement is terminated. On the other hand, when the carrier density is not included in the desired range (step S7: NO), a process of changing an impurity concentration (doping amount) of the sample S is performed (step S8). Thereafter, the processes from step S3 are performed again. According to the above processes, the impurity concentration of the sample S can be adjusted so that the carrier concentration (estimated value) of the sample S is included in the desired range.

In the interferometric measurement method using the interferometric measurement apparatus 1 described above, for each of a first state in which the sample S is not disposed in one optical path (the second optical path P2) of the interferometric optical system 20 and a second state in which the sample S is disposed, by performing measurement of the interference light IL while changing the optical path length difference Δd, a first interference waveform W1 and a second interference waveform W2 indicating an intensity of the interference light IL for each optical path length difference Δd are obtained (see FIG. 7). Furthermore, for each of the first interference waveform W1 and the second interference waveform W2, by converting the intensity of the interference light IL into an electric field amplitude, a first electric field amplitude waveform WE1 and a second electric field amplitude waveform WE2 are obtained (see FIG. 8). Then, based on the electric field amplitudes E1 and E2 corresponding to the peaks p1 and p2 of these respective electric field amplitude waveforms WE1 and WE2, a measurement value regarding a physical property of the sample S can be obtained. In the present embodiment, as the measurement value, the amplitude reflectance R of the sample S and the carrier density estimated based on the amplitude reflectance R were obtained. According to the interferometric measurement method, the physical property of the sample S can be grasped based on the measurement value obtained by irradiating the sample S with light (the second split light L2) without bringing a measuring instrument (probe) or the like into contact with the sample S. Therefore, according to the interferometric measurement method, the physical property of the sample S can be appropriately measured (evaluated) in a non-contact manner.

In the interferometric measurement method, the sample S is a semiconductor material. According to the above configuration, a physical property such as a carrier density of the sample S that is a semiconductor material can be easily measured by a non-contact measurement method. That is, since it is not necessary to bring a probe into contact with the sample S as in the conventional two-probe method and four-probe method, destruction of the sample S (for example, damage caused by the probe coming into contact with an unintended portion) can be avoided.

Further, it is preferable that a resistivity of the semiconductor material of the sample S is 4 Ωcm or less. That is, it is preferable that the sample S is a so-called low-resistivity substrate. According to the above configuration, by using a semiconductor material in which a change in the amplitude reflectance R (E2/E1) with respect to a change in a carrier density is relatively large as the sample S, the physical property of the sample S can be measured with higher accuracy based on the amplitude reflectance R.

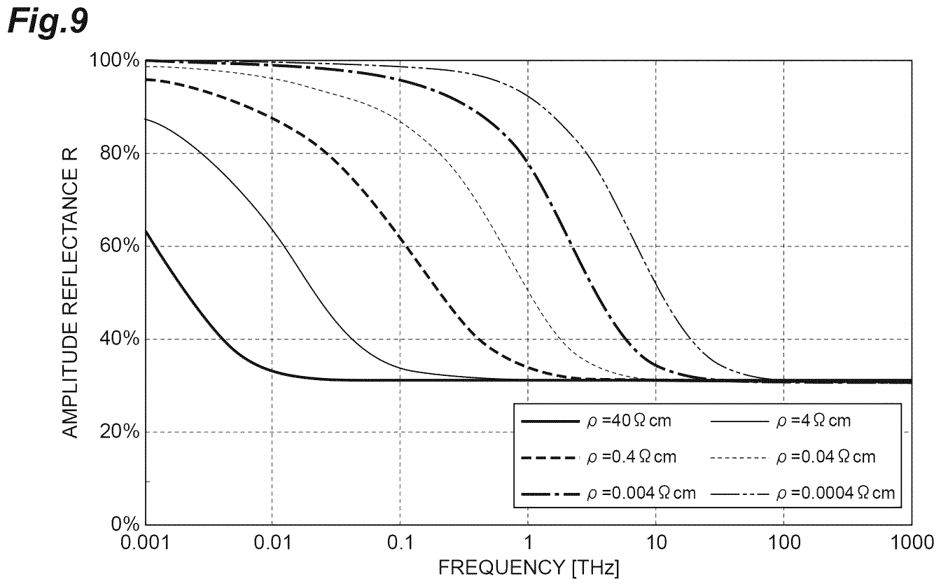

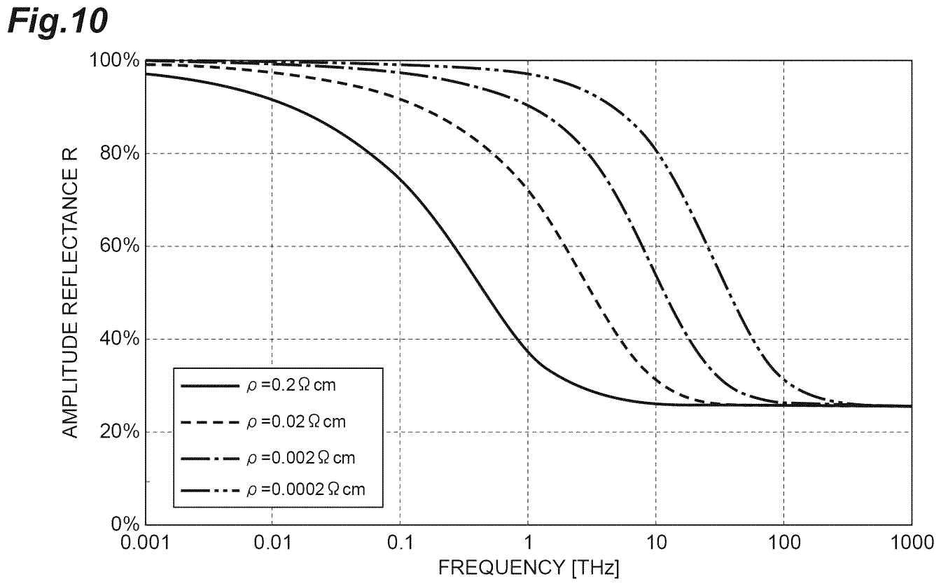

FIG. 9 shows a relationship of an amplitude reflectance R for each frequency of the measurement light L for each of a plurality of Si semiconductor substrates (an example of the sample S) having different resistivities p. FIG. 10 shows a relationship of an amplitude reflectance R for each frequency of the measurement light L for each of a plurality of GaN semiconductor substrates (an example of the sample S) having different resistivities ρ. Here, the carrier density and the resistivity p are closely related. That is, when the carrier density changes, the resistivity p of the sample S changes accordingly, and thereby the amplitude reflectance R changes. From FIGS. 9 and 10, it can be seen that although it depends on the material of the sample S, in a frequency range of 0.1 THz to 30 THz, a difference in the amplitude reflectance R due to a difference in the resistivity p (that is, a difference in the carrier density) is relatively large. From the above, it is preferable that the frequency of the measurement light L is included in a range of 0.1 THz to 30 THz. According to the above configuration, since a change in the amplitude reflectance R with respect to a change in the physical property (for example, carrier density) of the sample S can be made relatively large, the physical property of the sample S can be measured with higher accuracy based on the amplitude reflectance R. From the viewpoint of further improving the above effect, it is preferable that the frequency of the measurement light L is included in a range of 0.1 THz to 10 THz, more preferably in a range of 0.1 THz to 1 THz, and even more preferably in a range of 0.2 THz to 0.5 THz.

In the interferometric measurement method (the first measurement example), the processes of steps S3 to S6 are repeatedly executed while changing the impurity concentration of the sample S. In the present embodiment, the impurity concentration of the sample S is adjusted until the carrier density of the sample S falls within a desired range. According to the above configuration, by grasping physical property information (as an example, carrier density) of the sample S in each state while changing the impurity concentration of the sample S, a process of adjusting the impurity concentration of the sample S to a desired range (that is, an impurity concentration corresponding to a desired carrier density) can be easily and efficiently performed.

### Second Embodiment

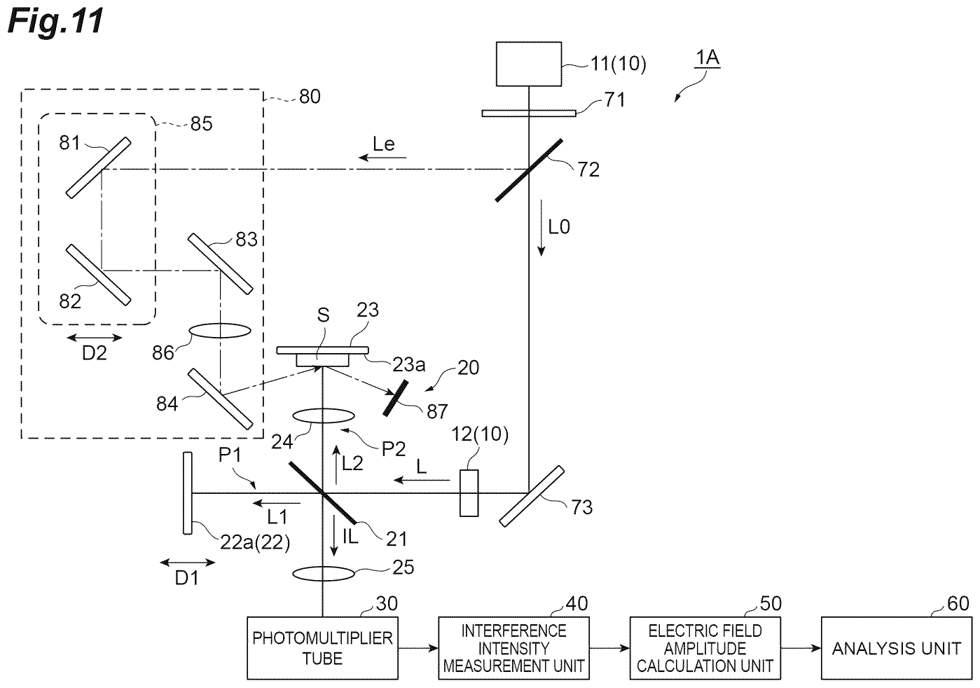

With reference to FIGS. 11 to 15, an interferometric measurement apparatus 1A according to a second embodiment will be described, and an interferometric measurement method (a second measurement example) using the interferometric measurement apparatus 1A will be described. In the second embodiment, as a measurement value regarding a physical property of the sample S, a measurement value regarding a time response of the sample S is acquired. As shown in FIG. 11, the interferometric measurement apparatus 1A is different from the interferometric measurement apparatus 1 in that it further includes a half-wave plate 71, a polarizing beam splitter 72, a mirror 73, and an excitation optical system 80. The half-wave plate 71, the polarizing beam splitter 72, and the mirror 73 are disposed between the output unit 11 and the optical crystal 12. The half-wave plate 71 is disposed between the output unit 11 and the polarizing beam splitter 72, and adjusts a polarization direction of the light output from the output unit 11. The polarizing beam splitter 72 splits the light output from the output unit 11 into light L0 that is transmitted through the polarizing beam splitter 72 and travels toward the interferometric optical system 20 via the mirror 73, and excitation light Le that is reflected by the polarizing beam splitter 72 and travels toward the excitation optical system 80, at a splitting ratio corresponding to the polarization direction of the light. In the present embodiment, by rotating the half-wave plate 71 to change the polarization direction of the light output from the output unit 11, a splitting ratio between the light L0 and the excitation light Le at the polarizing beam splitter 72 can be adjusted to an arbitrary ratio. Thereby, an intensity ratio between the excitation light Le and the light L0 can be appropriately and easily adjusted according to a type of the sample S or the like. When it is not necessary to adjust the splitting ratio between the light L0 and the excitation light Le as described above, the half-wave plate 71 may be omitted, and the polarizing beam splitter 72 may be a beam splitter whose splitting ratio does not change according to the polarization direction. The light L0 reflected by the mirror 73 is converted into the measurement light L by passing through the optical crystal 12, and travels toward the interferometric optical system 20 (the beam splitter 21) as in the first embodiment. The optical crystal 12 may be disposed at a position upstream of the mirror 73 (a position between the polarizing beam splitter 72 and the mirror 73).

The excitation optical system 80 includes mirrors 81 to 84, a moving mechanism 85 that moves the mirrors 81 and 82, a lens 86, and a damper 87. The mirrors 81 to 84 are arranged such that the excitation light Le is reflected in this order. That is, the excitation light Le reflected by the mirror 81 travels toward the mirror 82, the excitation light Le reflected by the mirror 82 travels toward the mirror 83, and the excitation light Le reflected by the mirror 83 travels toward the mirror 84. The excitation light Le reflected by the mirror 84 irradiates the sample S disposed on the mirror surface 23a of the second mirror 23.

The moving mechanism 85 moves the mirrors 81 and 82 integrally in a direction D2 such that a distance between the mirrors 81 and 82 is constant, and a distance from the polarizing beam splitter 72 to the mirror 81 and a distance between the mirrors 82 and 83 vary. By the movement of the mirrors 81 and 82 by the moving mechanism 85, an optical path length of the excitation light Le from the polarizing beam splitter 72 to the sample S changes. That is, by adjusting positions of the mirrors 81 and 82 by the moving mechanism 85, it is possible to control a delay time which is a time difference between a first timing at which the measurement light L (the second split light L2) is incident on the sample S and a second timing at which the excitation light Le is irradiated on the sample S by the excitation optical system 80.

The lens 86 is disposed between the mirrors 83 and 84. The lens 86 is a lens for condensing the excitation light Le on an irradiation position (a target position) of the sample S. When a distance from the mirror 84 to the sample S is long, the lens 86 may be disposed between the mirror 84 and the sample S.

The damper 87 is disposed at a position toward which the excitation light Le reflected by the sample S travels. The damper 87 plays a role of preventing the excitation light Le from being incident on other optical elements or the like by blocking the excitation light Le.

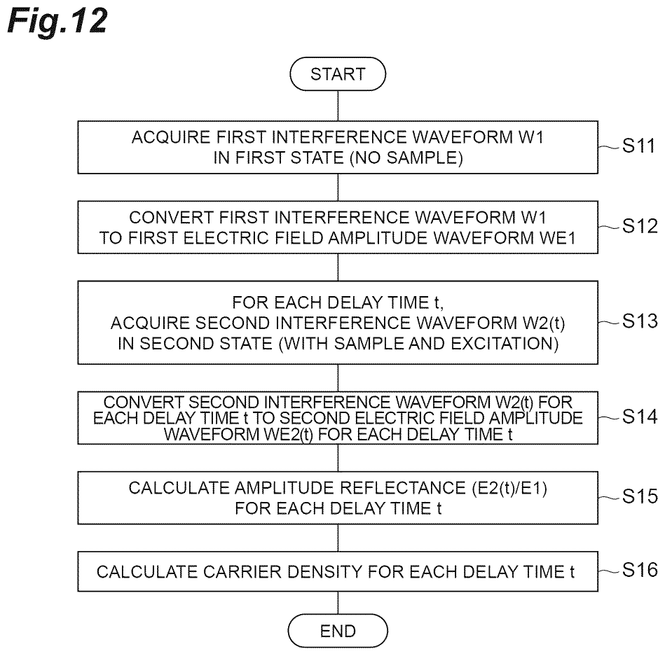

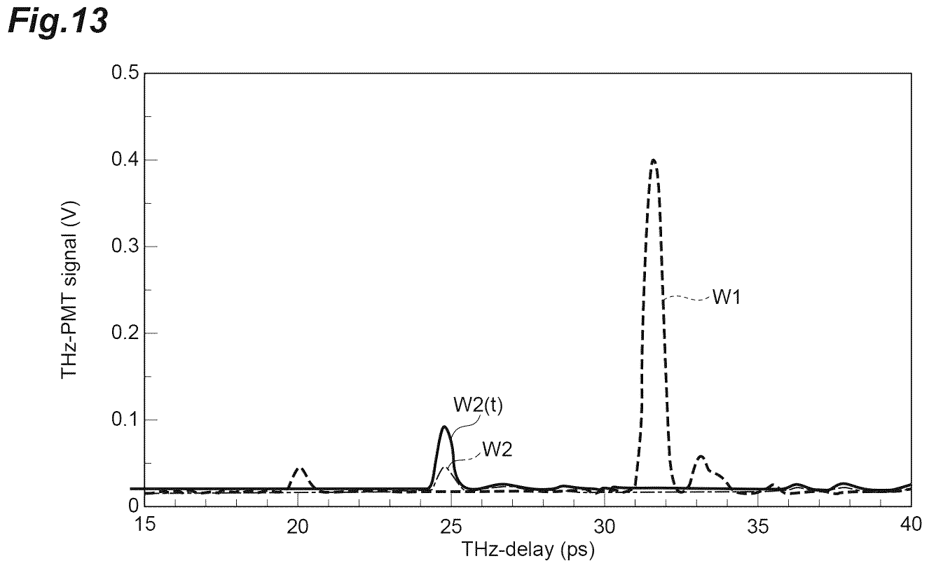

An example (a second measurement example) of an interferometric measurement method by the interferometric measurement apparatus 1A will be described with reference to the flowchart of FIG. 12 and examples of measurement results of FIGS. 13 to 15. As an example, in the second measurement example, by performing measurement while changing the delay time described above, a carrier density of the sample S in each state for each delay time is estimated, and a time response characteristic of the photo-excited sample S is evaluated.

Steps S11 and S12 (first step and second step) are the same as steps S1 and S2 of the first measurement example (FIG. 6). That is, by steps S11 and S12, a first interference waveform W1 and a first electric field amplitude waveform WE1 in a first state (a state in which there is no sample S to be irradiated with the excitation light Le, and thus irradiation with the excitation light Le is not performed) are acquired. In the interferometric measurement apparatus 1A, in order to execute steps S11 and S12, for example, by disposing a damper (a member similar to the damper 87) that blocks the excitation light Le at an arbitrary position in the excitation optical system 80, the excitation light Le can be prevented from being irradiated on the mirror surface 23a.

Step S13 (third step) is a modification of the process of step S3 of the first measurement example (FIG. 6) to be executed for each combination of the delay time t and the optical path length difference Δd described above. That is, step S13 acquires a second interference waveform W2(t) for each delay time t by controlling a delay time t, which is a time difference (t2−t1) between a timing t1 at which the second split light L2 is incident on the sample S and a timing t2 at which the excitation light Le is irradiated on the sample S by the excitation optical system 80, to change a combination of the delay time t and the optical path length difference Δd, and performing measurement by the interference intensity measurement unit 40 for each combination. The delay time “t=0” indicates a state in which the second split light L2 and the excitation light Le are simultaneously incident and irradiated on the sample S, the delay time “t>0” indicates a state in which the excitation light Le is irradiated on the sample S before the second split light L2, and the delay time “t<0” indicates a state in which the second split light L2 is incident on the sample S before the excitation light Le.

FIG. 13 is a graph having the same horizontal and vertical axes as FIG. 7, and shows a second interference waveform W2(t) corresponding to a certain delay time t (t>0). In the example of FIG. 13, the carrier density of the sample S is temporarily changed (increased) by irradiating the sample S with the excitation light Le, and as a result, a reflectance of the measurement light L at the sample S is improved as compared with a state without photo-excitation. As a result, an intensity of the interference light IL incident on the photomultiplier tube 30 increases, whereby a peak value of the second interference waveform W2(t) is larger than a peak value of the second interference waveform W2 (see FIG. 7).

The process of step S13 can be executed, for example, as follows. First, the delay time t is set to a certain value by adjusting an optical path length of the excitation light Le in the excitation optical system 80 by the moving mechanism 85. Subsequently, similarly to step S3 of the first measurement example (FIG. 6), measurement corresponding to each optical path length difference Δd is performed while changing the optical path length difference Δd. Thereby, a second interference waveform W2(t) for a certain delay time t is obtained. By executing the above process while changing the delay time t, a second interference waveform W2(t) corresponding to each of a plurality of delay times t is obtained.

Step S14 (fourth step) is a modification of the process of step S4 of the first measurement example (FIG. 6) to be executed for each combination of the delay time t and the optical path length difference Δd. That is, step S14 acquires a second electric field amplitude waveform WE2(t) for each delay time t by performing the same conversion process as in step S4 on the second interference waveform W2(t) for each delay time t.

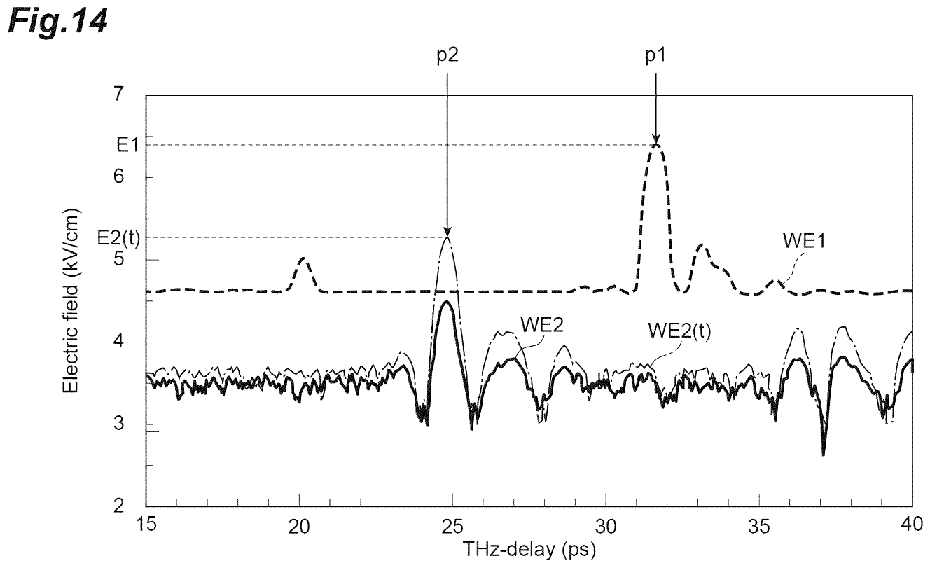

FIG. 14 is a graph having the same horizontal and vertical axes as FIG. 8, and shows a second electric field amplitude waveform WE2(t) corresponding to a certain delay time t (the same as the delay time t of FIG. 13). In FIG. 14, a second electric field amplitude waveform WE2 (a waveform obtained by the first measurement example) in a case where photo-excitation is not performed is also shown. In the example of FIG. 14, as described above, as a result of the peak value of the second interference waveform W2(t) being larger than the peak value of the second interference waveform W2, E2(t), which is a peak value of the second electric field amplitude waveform WE2(t), is larger than E2, which is a peak value of the second electric field amplitude waveform WE2.

Step S15 (fifth step) is a modification of the process of step S5 of the first measurement example (FIG. 6) to be executed for each combination of the delay time t and the optical path length difference Δd. That is, step S15 is a process of calculating an amplitude reflectance R(t) (=E2(t)/E1) for each delay time t.

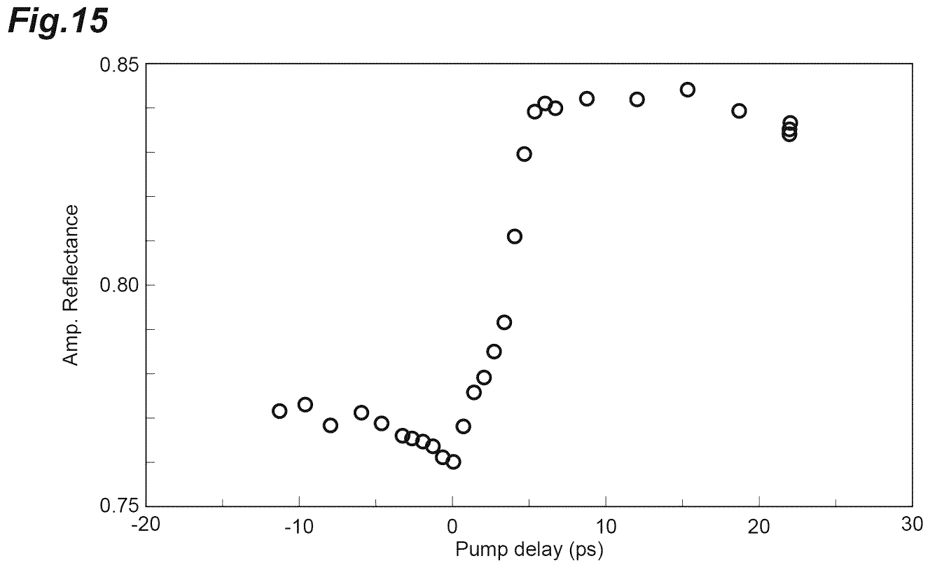

FIG. 15 is a diagram showing an example of an amplitude reflectance R(t) for each delay time. The graph of FIG. 15 has a delay time on a horizontal axis and an amplitude reflectance on a vertical axis, and amplitude reflectances R(t) corresponding to several delay times t are plotted. As shown in FIG. 15, according to the second measurement example, a time response characteristic (a magnitude of the amplitude reflectance R(t) with respect to the delay time t) of the sample S with respect to photo-excitation for each delay time t can be grasped. That is, step S15 is an example of a process of acquiring a measurement value (here, the amplitude reflectance R(t)) regarding a time response of the sample S based on electric field amplitudes E1 and E2(t) corresponding to respective peaks p1 and p2 of the first electric field amplitude waveform WE1 and the second electric field amplitude waveform WE2(t) for each delay time t.

Step S16 (fifth step) is a modification of the process of step S6 of the first measurement example (FIG. 6) to be executed for each combination of the delay time t and the optical path length difference Δd. That is, step S16 is a process of calculating (estimating) a carrier density corresponding to the amplitude reflectance R(t) for each delay time t. Step S16 is an example of a process of acquiring a measurement value (here, a carrier density for each delay time t) regarding a time response of the sample S based on the electric field amplitudes E1 and E2(t) corresponding to the respective peaks p1 and p2 of the first electric field amplitude waveform WE1 and the second electric field amplitude waveform WE2(t) for each delay time t.

As described above, the interferometric measurement apparatus 1A includes the excitation optical system 80 that irradiates the sample S disposed in the second optical path P2 with the excitation light Le when in the second state. Further, the interferometric measurement method using the interferometric measurement apparatus 1A includes a step of acquiring a second interference waveform W2(t) for each delay time t by controlling a delay time t, which is a time difference (t2−t1) between a timing t1 at which the second split light L2 is incident on the sample S and a timing t2 at which the excitation light Le is irradiated on the sample S by the excitation optical system 80, to change a combination of the delay time t and the optical path length difference Δd, and performing measurement by the interference intensity measurement unit 40 for each combination (as an example, step S13 of FIG. 12), a step of acquiring a second electric field amplitude waveform WE2(t) for each delay time t (as an example, step S14 of FIG. 12), and a step of acquiring a measurement value regarding a time response of the sample S based on the electric field amplitudes E1 and E2(t) corresponding to the respective peaks p1 and p2 of the first electric field amplitude waveform WE1 and the second electric field amplitude waveform WE2(t) for each delay time t (as an example, steps S15 and S16 of FIG. 12). Step S15 acquires an amplitude reflectance R(t) for each delay time t as the measurement value regarding the time response of the sample S. Step S16 acquires a carrier density for each delay time t as the measurement value regarding the time response of the sample S. According to the above configuration, a time response of a physical property of the sample S irradiated with the excitation light Le can be evaluated. For example, from the carrier density for each delay time t, a dynamic evaluation such as a relaxation time of carriers photo-excited in the sample S can be performed.

The sample S is a semiconductor material, and the excitation light Le (in the present embodiment, the light L0 output from the output unit 11) is visible light or near-infrared light. According to the above configuration, since carriers of the semiconductor sample (the sample S) can be efficiently excited by the excitation light Le, a physical property of the semiconductor sample can be suitably evaluated.

Further, in the interferometric measurement method using the interferometric measurement apparatus 1A, a part of the light L0 generated in the light source 10 (the output unit 11) is made incident on the optical crystal 12 to generate the measurement light L, and another part of the light L0 generated in the light source 10 (the output unit 11) is input to the excitation optical system 80 as the excitation light Le, and the delay time t is controlled by changing an optical path length of the excitation light Le in the excitation optical system 80. In the present embodiment, by scanning the moving mechanism 85, the optical path length of the excitation light Le changes, and as a result, the delay time t changes. According to the above configuration, the measurement light L and the excitation light Le can be generated from one light source 10 (the output unit 11), and the delay time t can be easily controlled (set) by changing the optical path length of the excitation optical system 80.

Further, the interferometric measurement apparatus 1A includes the excitation optical system 80 that irradiates the sample S disposed in the second optical path P2 with the excitation light Le when in the second state, and the light source 10 that generates the light L0, generates the measurement light L by causing a part of the light L0 to be incident on the optical crystal 12, and inputs another part of the light L0 to the excitation optical system 80 as the excitation light Le. The optical path length of the excitation light Le in the excitation optical system 80 is configured to be variable. The interferometric measurement apparatus 1A can implement the interferometric measurement method described above, and thus can appropriately measure the physical property of the sample S in a non-contact manner. Further, the interferometric measurement apparatus 1A includes the excitation optical system 80 together with the interferometric optical system 20, and thus can evaluate a time response of a physical property (in the present embodiment, amplitude reflectance, carrier density, etc.) of the sample S irradiated with the excitation light Le. Further, since the measurement light L and the excitation light Le can be generated from one light source 10 (the output unit 11), the apparatus configuration can be simplified and downsized as compared with a case where the measurement light L and the excitation light Le are output from separate light sources. Further, by changing the optical path length of the excitation optical system 80, the delay time t between the timing at which the measurement light L (the second split light L2) is incident on the sample S and the timing at which the excitation light Le is irradiated can be easily set, so that a measurement value regarding the time response can be easily obtained.

### MODIFICATIONS

Although some embodiments of the present disclosure have been described above, the present disclosure is not limited to the configurations shown in the above embodiments. For materials and shapes of each component, various materials and shapes other than those specifically described above can be adopted. Further, some of the configurations included in the above embodiments may be appropriately omitted or changed, and can be arbitrarily combined.

For example, a processing flow of the interferometric measurement method described above is not limited to those shown in FIGS. 6 and 12. For example, in the first measurement example shown in FIG. 6, steps S3 and S4 may be executed before steps S1 and S2. Further, after steps S1 and S3 are executed, steps S2 and S4 may be executed. Further, when performing physical property evaluation for a completed sample S, steps S7 and S8 may be omitted. Further, for example, when only the amplitude reflectance R is obtained as physical property information of the sample S (for example, when the carrier density is not used for physical property evaluation of the sample S), the measurement may be completed after obtaining the amplitude reflectance R in step S5.

Further, the first measurement example and the second measurement example described above may be combined. For example, in a semiconductor process for increasing a carrier density of the sample S, the carrier density of the sample S may be monitored by the first measurement example (measurement without photo-excitation), and a time response of carriers in the sample S may be evaluated by the second measurement example (measurement with photo-excitation). For example, using the interferometric measurement apparatus 1A including the excitation optical system 80 in addition to the interferometric optical system 20, S1 to S6 of the first measurement example may be performed in a state where photo-excitation to the sample S is blocked, and S13 to S16 of the second measurement example may be performed. In this case, by evaluating the time response of the carriers in addition to the carrier density in the first measurement example, it can be evaluated whether or not the carriers are uniformly doped on a surface (wafer surface) of the sample S. For example, when the carriers are not uniformly doped on the surface of the sample S, a mobility of the carriers changes, and thus it exhibits a time response different from that in a case where the carriers are uniformly doped.

Further, control of the delay time in the interferometric measurement apparatus 1A (that is, a configuration in which the excitation optical system 80 is provided in addition to the interferometric optical system 20) may be performed by making a light source of the measurement light L and a light source of the excitation light Le different, and controlling a timing of outputting the excitation light Le from the light source of the excitation light Le. However, in this case, it is necessary to control timings of pulse outputs of two different light sources with high accuracy. Therefore, by making the light source (the output unit 11) of the excitation light Le and the measurement light common as in the above embodiment and making the optical path length of the excitation optical system 80 variable, the delay time can be easily adjusted.

Further, the photomultiplier tube 30 may be capable of imaging an incident light intensity distribution. When the electron multiplication part 32 includes a microchannel plate (for example, the photomultiplier tube 30 is an image intensifier), imaging of the incident light intensity distribution is possible. By using such a photomultiplier tube 30, analysis imaging of the sample S becomes possible.

Further, the sample S may be configured by a material other than a semiconductor material as long as its physical property can be evaluated by a measurement value (for example, amplitude reflectance) obtained by the interferometric measurement method as described above. For example, the sample S may be a substance other than a semiconductor having a property of responding to light. For example, the sample S may be a nonlinear optical crystal (for example, ZnTe, LiTiO3, etc.). In a nonlinear optical crystal, a response time to light, a complex refractive index, and the like are important physical property parameters. The interferometric measurement method described above is useful because it can measure the physical property parameters as described above non-destructively even for the sample S other than such a semiconductor material.

What is claimed is:

1. An interferometric measurement method using an interferometric measurement apparatus,
wherein the interferometric measurement apparatus comprises:
a light source that outputs measurement light having a frequency included in a range of 0.1 THz to 50 THz;
an interferometric optical system that includes: a beam splitter that splits the measurement light into a first split light and a second split light; a first optical path for the first split light from being output from the beam splitter to re-entering the beam splitter; and a second optical path, which is different from the first optical path, for the second split light from being output from the beam splitter to re-entering the beam splitter, the second optical path being configured to be switchable between a first state in which a sample is not disposed and a second state in which the sample is disposed, wherein the interferometric optical system combines the first split light and the second split light re-entering the beam splitter, and an optical path length difference between the first optical path and the second optical path is variable;
a photomultiplier tube that outputs an electrical signal value corresponding to an incident light intensity of interference light of the measurement light, the interference light being generated by combination of the first split light and the second split light at the beam splitter;
an interference intensity measurement unit that measures an intensity of the interference light based on the electrical signal value output from the photomultiplier tube; and
an electric field amplitude calculation unit that determines an electric field amplitude of the interference light from the intensity of the interference light measured by the interference intensity measurement unit, based on a relationship between a value of an electric field amplitude of light incident on the photomultiplier tube and a value of an electrical signal output from the photomultiplier tube,
the method comprising:
a first step of acquiring a first interference waveform indicating the intensity of the interference light for each optical path length difference in the first state, by performing the measurement by the interference intensity measurement unit while changing the optical path length difference in the first state;
a second step of converting the first interference waveform into a first electric field amplitude waveform, which is a waveform of the electric field amplitude, by the electric field amplitude calculation unit;
a third step of acquiring a second interference waveform indicating the intensity of the interference light for each optical path length difference in the second state, by performing the measurement by the interference intensity measurement unit while changing the optical path length difference in the second state;
a fourth step of converting the second interference waveform into a second electric field amplitude waveform, which is a waveform of the electric field amplitude, by the electric field amplitude calculation unit; and
a fifth step of acquiring a measurement value regarding a physical property of the sample, based on an electric field amplitude corresponding to each peak of the first electric field amplitude waveform and the second electric field amplitude waveform.

2. The interferometric measurement method according to claim 1,
wherein the sample is a semiconductor material.

3. The interferometric measurement method according to claim 2,
wherein a resistivity of the semiconductor material is 4 Ωcm or less.

4. The interferometric measurement method according to claim 1,
wherein the frequency of the measurement light is included in a range of 0.1 THz to 30 THz.

5. The interferometric measurement method according to claim 4,
wherein the frequency of the measurement light is included in a range of 0.1 THz to 10 THz.

6. The interferometric measurement method according to claim 1,
wherein in the fifth step, the measurement value regarding the physical property of the sample is acquired based on an electric field amplitude corresponding to a largest peak of the first electric field amplitude waveform and an electric field amplitude corresponding to a largest peak of the second electric field amplitude waveform.

7. The interferometric measurement method according to claim 1,
wherein the interferometric measurement apparatus further comprises an excitation optical system that irradiates the sample disposed in the second optical path with excitation light when in the second state,
the third step acquires the second interference waveform for each delay time by: controlling a delay time, which is a time difference between a timing at which the second split light is incident on the sample and a timing at which the sample is irradiated with the excitation light by the excitation optical system, to change a combination of the delay time and the optical path length difference; and performing the measurement by the interference intensity measurement unit for each combination,
the fourth step acquires the second electric field amplitude waveform for each delay time, and
the fifth step acquires a measurement value regarding a time response of the sample, based on an electric field amplitude corresponding to each peak of the first electric field amplitude waveform and the second electric field amplitude waveform for each delay time.

8. The interferometric measurement method according to claim 7,
wherein the sample is a semiconductor material, and
the excitation light is visible light or near-infrared light.

9. The interferometric measurement method according to claim 7,
wherein a part of light generated in the light source is made incident on an optical crystal to generate the measurement light, and another part of the light generated in the light source is input to the excitation optical system as the excitation light, and
the delay time is controlled by changing an optical path length of the excitation light in the excitation optical system.

10. The interferometric measurement method according to claim 2,
wherein processes of the third step, the fourth step, and the fifth step are repeatedly executed while changing an impurity concentration of the sample.

11. An interferometric measurement apparatus comprising:
an interferometric optical system that includes: a beam splitter that splits measurement light having a frequency included in a range of 0.1 THz to 50 THz into a first split light and a second split light; a first optical path for the first split light from being output from the beam splitter to re-entering the beam splitter; and a second optical path, which is different from the first optical path, for the second split light from being output from the beam splitter to re-entering the beam splitter, the second optical path being configured to be switchable between a first state in which a sample is not disposed and a second state in which the sample is disposed, wherein the interferometric optical system combines the first split light and the second split light re-entering the beam splitter, and an optical path length difference between the first optical path and the second optical path is variable;
an excitation optical system that irradiates the sample disposed in the second optical path with excitation light when in the second state;
a light source that generates light, generates the measurement light by causing a part of the light to be incident on an optical crystal, and inputs another part of the light to the excitation optical system as the excitation light;
a photomultiplier tube that outputs an electrical signal value corresponding to an incident light intensity of interference light of the measurement light, the interference light being generated by combination of the first split light and the second split light at the beam splitter;
an interference intensity measurement unit that measures an intensity of the interference light based on the electrical signal value output from the photomultiplier tube; and
an electric field amplitude calculation unit that determines an electric field amplitude of the interference light from the intensity of the interference light measured by the interference intensity measurement unit, based on a relationship between a value of an electric field amplitude of light incident on the photomultiplier tube and a value of an electrical signal output from the photomultiplier tube,
wherein an optical path length of the excitation light in the excitation optical system is configured to be variable.
